(19) United States
(12) Patent Application Publication
(10) Pub. No.: US 2007/0171548 A1
(43) Pub. Date: Jul. 26, 2007

(54) Optical device assembly method

(76) Inventors: Robert Steven Kulakofsky, Tucson, AZ (US); Horst Helmut Krupp, La Costa, CA (US)

Correspondence Address: Robert Kulakofsky, PO Box 26761, Tucson, AZ, 85726, US

(21) Appl. No.: 11/337,420

(22) Filed: Jan. 23, 2006

(51) Int. Cl. G02B 7/02

(52) U.S. Cl. 359/808; 359/819

(57) ABSTRACT

Our improved optical device assembly method uses a compressible item such as a spring to separate and seat the internal components. Our method is affordable and easy to manufacture. It also eliminates the need for special tools, adhesives or a considerable amount of time to assemble an optical device. Our preferred method of assembly is adjustable to a variance in the dimensions of the internal components. The housing (10) for this device contains a lens (12) and filter (16) that are separated by use of a spring (14) which also functions as a positioning device for both internal items. A plug (18) will be mounted at one end of the optical device to hold the internal components and spring in the housing.

### CROSS-REFERENCE TO RELATED APPLICATIONS

The application claims the benefit of provisional patent application Ser. No 60/629885, filed by the inventors on Nov. 19, 2004.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to optical applications that require a number of lenses or other optical components to be spaced and properly seated in a cylindrical housing.

2. Prior Art

Previously, housings for optical devices had a cylindrical cavity and used various adhesives or threaded inserts to properly hold lenses or filters in a desired position. These methods are costly and time consuming to manufacture and require additional care to replace the internal components. For example: removing a threaded insert can result in scratches on the item being removed. In the case where items have been glued in an assembly, they can not be removed without the use of chemicals to break down the adhesive.

Having an internal or external threaded device to enclose the lenses or filters adds time to both the machining and assembly which results in a higher production cost. For the internal thread method, additional tools such as taps would be needed to thread the inner diameter and threading would be needed on the mating part. The internal threaded insert is a standard practice that requires a special tool (commonly called a spanner wrench) to spin the insert until it makes proper contact with the lens, filter or other internal components.

The following patents are a few examples of optic components and housings that are assembled using adhesives. The method for securing optical parts in U.S. Pat. No. 5,050,963 to Murakami, 1991 Sep. 24, has three members which are secured with adhesive applied onto a groove. With this method, the three members are permanently secured and can not be repaired without replacing the entire assembly. The lens holder for positioning and holding the objective lens in U.S. Pat. No. 5,781,351 to Murakami, 1998 Jul. 14, has two inner walls between which an annular shoulder portion is formed. Again an adhesive agent is applied to a gap defined between the first inner wall and the outer ring of the objective lens.

The lens holder in U.S. Pat. No. 6,172,822 to Belliveau 2001 Jan. 9, uses a split housing which consists of a molded bottom cover and top cover. The top cover clips to the bottom cover by a set of clips on each side of the housing. This method has expensive molding costs and the housing is limited to a material which is flexible enough to continuously snap into the adjacent cover. In this assembly the lenses are slid into slots that were part of the molding. This design is limited to the predetermined slot locations.

### BACKGROUND OF THE INVENTION—OBJECTS AND ADVANTAGES

Accordingly, besides the objects and advantages of the adjustable internal component several objects and advantages of the invention are:
a) to provide an optical housing that can be manufactured quickly and at low cost;
b) to provide a closure whose production allows for a convenient and rapid assembly of the internal components;
c) to provide an assembly that eliminates the need for unnecessary operations and tooling;
d) to provide a closure that is flexible to the variance in dimensions of the internal components;
e) to provide an assembly that does not require a highly skilled worker to produce the final product;
f) to provide an optical housing that properly seats the lenses, filters or other internal components with very little effort;
g) to provide an optical housing assembly that does not require adhesives;
h) to provide an optical housing that allows access to the internal components if repairs are needed;

Further objects and advantages will become apparent from a consideration of the ensuing description and drawings.

### SUMMARY

In accordance with the preferred assembly method, an optical device with a cylindrical cavity consists of a spring to seat and separate the internal components. The internal components are held in place with a nylon plug. As the manufacturer we are also concerned that our final product can be assembled without spending a lot of time, money and preferably not having to use an adhesive.

In the drawings, closely related figures to the preferred embodiment have the same number but different alphabetic suffixes.

### DRAWINGS—FIGURES

FIG. 1A shows an exploded view of our invention

FIG. 1B shows an assembled view of the internal components

FIG. 1C is a view in detail of the portion indicated by the section lines A-A in FIG. 1B

FIG. 1D is a view in detail of the portion indicated by the section circle B in FIG. 1C

FIG. 2 is a side view of the nylon plug

FIG. 3 is an isometric view of the nylon plug

FIG. 4 is a view in detail of the portion indicated by the section lines B-B. It shows a similar assembly without the use of the spring

FIG. 5 is a view in detail of the portion indicated by the section lines D-D. It shows a similar assembly that uses a threaded insert

FIG. 6 is a view in detail of the portion indicated by the section circle C in FIG. 5

FIG. 7 a view in detail of the portion indicated by the section lines F-F. It shows a similar assembly with an added sleeve as an internal component

FIG. 8A shows an exploded view of the two part housing method

FIG. 8B shows an assembled view of the two housing components

FIG. 8C is a view in detail of the portion indicated by the section lines G-G in FIG. 8B

FIG. 8D is a view in detail of the portion indicated by the section lines H-H. It shows an assembled view with all the internal components

FIG. 9A shows an assembled view of the two housing components without the use of a plug

FIG. 9B is a view in detail of the portion indicated by the section lines J-J in FIG. 9A

FIG. 9C is a view in detail of the portion indicated by the section lines L-L. It shows an assembled view with all the internal components

FIG. 10A shows an assembled view of the outer and inner housing being used to seat an internal component

FIG. 10B is a view in detail of the portion indicated by the section lines M-M in FIG. 10A

FIG. 10C is a view in detail of the portion indicated by the section lines N-N. It shows an assembled view with all the internal components

FIG. 11A is a view in detail of the portion indicated by the section lines P-P. It shows a sectioned view of the outer and inner housing that is threaded together

FIG. 11B is a view in detail of the portion indicated by the section lines R-R. It shows an assembled view of the internal components in the outer and inner housing that is threaded together

FIG. 12 is a view in detail of the portion indicated by the section lines T-T. It shows an assembled view that uses a sleeve to hide the spring

### DRAWINGS—REFERENCE NUMERALS

10 housing
12 lens
14 spring
16 filter
18 plug
20 groove on mentioned housing
22 countersunk end
24 contact point for the mentioned lens
26 contact point for the mentioned plug
28 sleeve
30 O-ring or washer
32 threaded insert
34 compressible item
36 chamfer
38 inner housing
40 outer housing
42 thread

### DETAILED DESCRIPTION

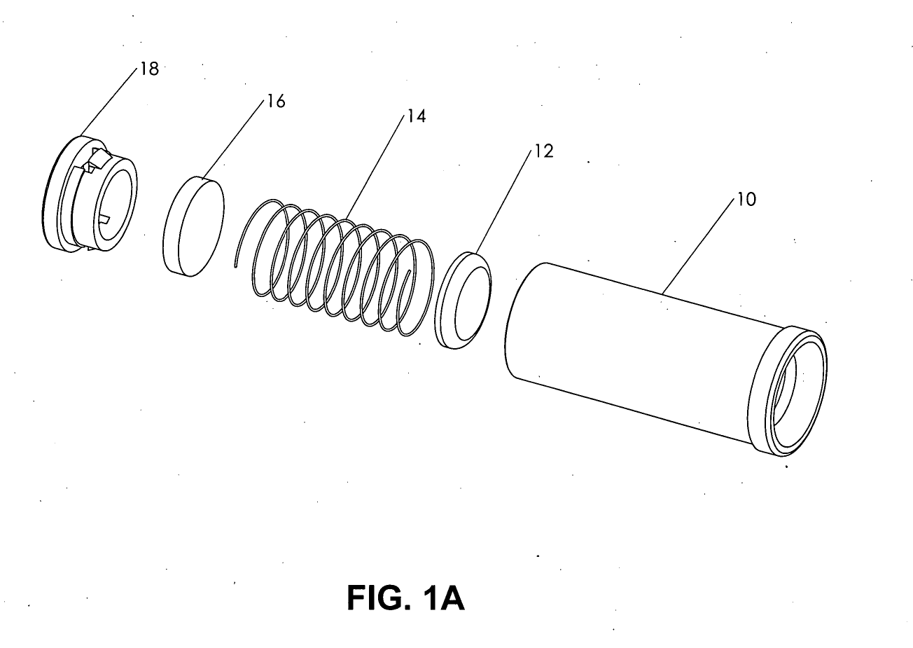

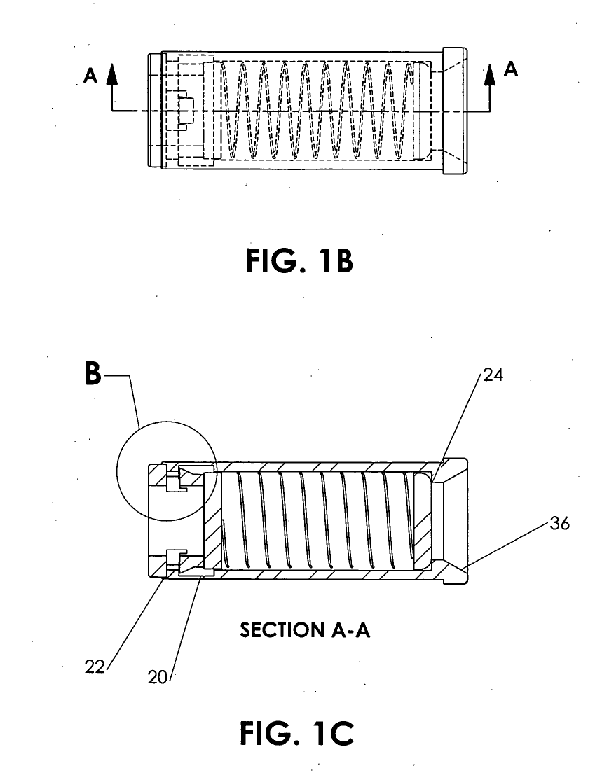

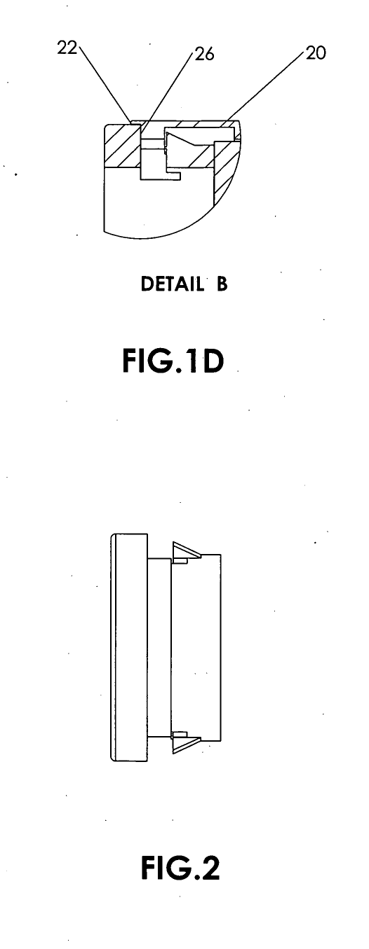

### Preferred Embodiment—FIGS. 1A, 1B, 1C, 1D, 2 and 3

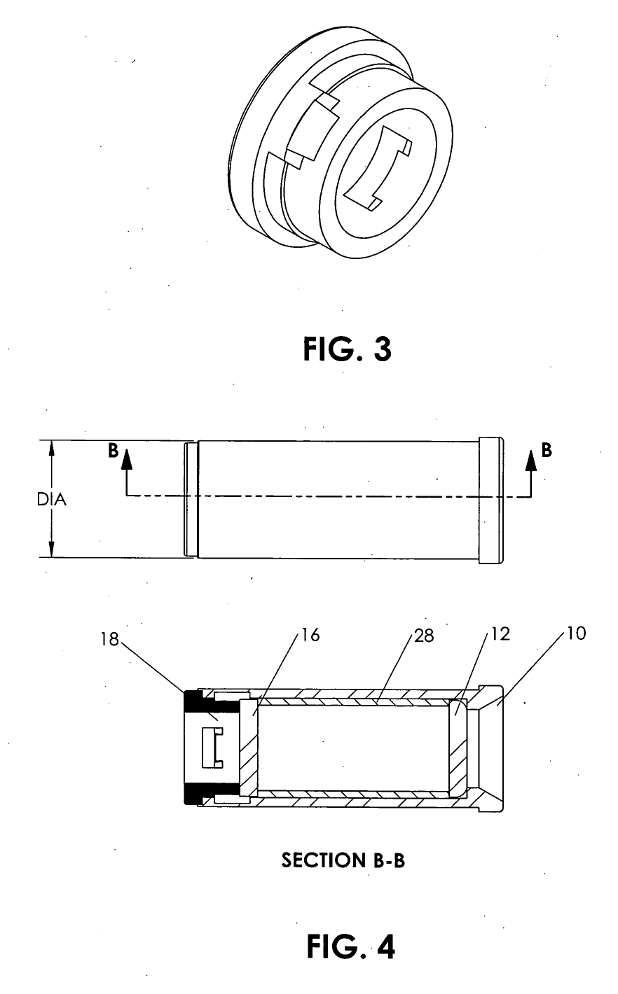

A preferred embodiment of the assembly of the present invention is illustrated in FIG. 1A (exploded view), FIG. 1B (assembled view), FIG. 1C (assembly section), and FIG. 1D (detailed view). As illustrated in FIG. 1A, the housing 10 will have three internal components that will be held in place with a plug 18. A lens 12 is the first internal component that is inserted into the housing which will make contact at point 24 in FIG. 1C. Following the lens is a spring 14 that will provide the desired spacing and keep the lens properly seated. The last internal component is a filter 16 that will be properly seated inside the housing with help from the other side of the spring. The plug is pressed into the housing until the plug snaps into a groove 20 in FIG. 1C and makes contact at point 26 as illustrated in FIG. 1D. The groove may be formed by machining, molding, extruding, or a combination of operations. FIGS. 1C and 1D show how the housing will have a countersunk end 22 so that the plug will be less visible to the user. The force created by the spring will the internal components securely in place. In the preferred embodiment, the plug is a flexible nylon type 6/6 that is called a shorty bushing and is available from Heyco Products, Inc. The nylon plug currently being used as our preferred design is shown in detail in FIGS. 2 and 3. This plug however can consist of any other material that is flexible enough to snap into the groove without fracturing, such as polyethylene, polypropylene, rubber, various plasticized materials, thin steel, etc.

### Operation—Preferred Embodiment—FIGS. 1A, 1B, 1C, 1D, 2 and 3

As illustrated in FIG. 1A, the housing 10 will have three internal components that will be held in place with a plug 18. The function of the housing is to protect the internal components. To make the viewing end of the device obvious to the user the housing has a chamfer 36 on the viewing end which is shown in FIG. 1C. A lens 12 is the first internal component that is inserted into the housing which will make contact at point 24 in FIG. 1C. In the present invention the lens is a magnifier that is used for identifying and viewing inclusions or fractures of a gemstone. Following the lens is a spring 14 that will provide the desired space and keep the lens properly seated. The last internal component is a filter 16 that will be properly seated inside the housing with help from the other side of the spring. The plug is pressed into the housing until the plug snaps into a groove 20 in FIG. 1C and makes contact at point 26 as illustrated in FIG. 1D. The groove can vary in depth and width depending on the overall dimensions of the housing and type of plug being used. FIGS. 1C and 1D show how the housing will have a countersunk end 22 so that the plug will be less visible to the user. The nylon plug currently being used as our preferred design is shown in detail in FIGS. 2 and 3.

### Description—Alternative Embodiment—FIGS. 4-12

Additional embodiments are shown in FIGS. 4, 5, 6, 7, 8A-8D, 9A-9C, 10A-10C, 11A, 11B and 12; in each case the changes made still provide the proper separation and seating of the internal components.

In FIG. 4 a sleeve 28 is used to separate the lens and filter. A plug 18 is still used to keep the internal components properly seated. However, this assembly would not be as forgiving to variances in part dimensions. This method of assembly is relying on exact dimensions of all the internal components otherwise the plug may not make proper contact with the filter.

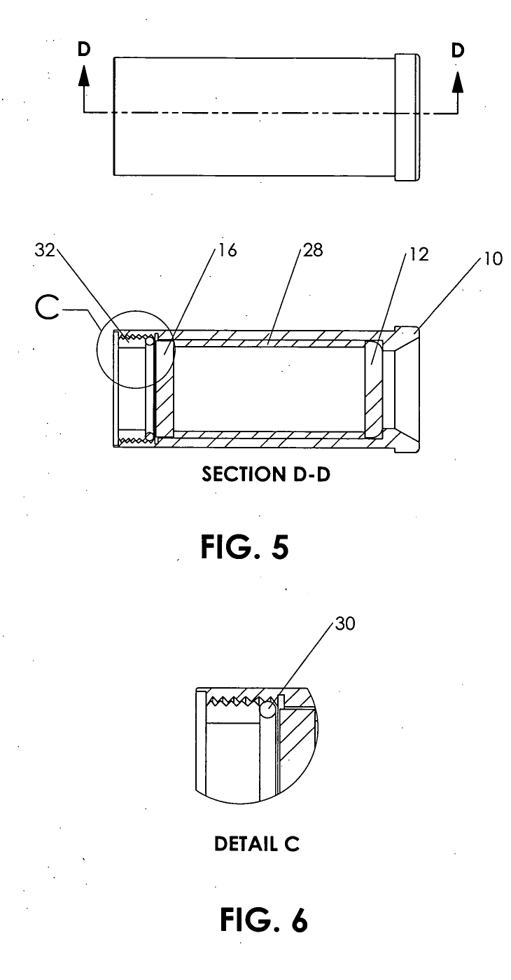

In FIG. 5 a threaded insert is used to make contact with the filter and the sleeve mentioned in FIG. 4 keeps the internal components properly separated. This method is not being used because it is too similar to our competitor's ideas and requires a special tool to insert the threaded retainer. More importantly the threading is an added expense and more time consuming for mass production. FIG. 6 is a view in detail of the portion indicated by the section circle C in FIG. 5 which shows how an O-ring or washer 30 could be used to protect the filter from the threaded insert.

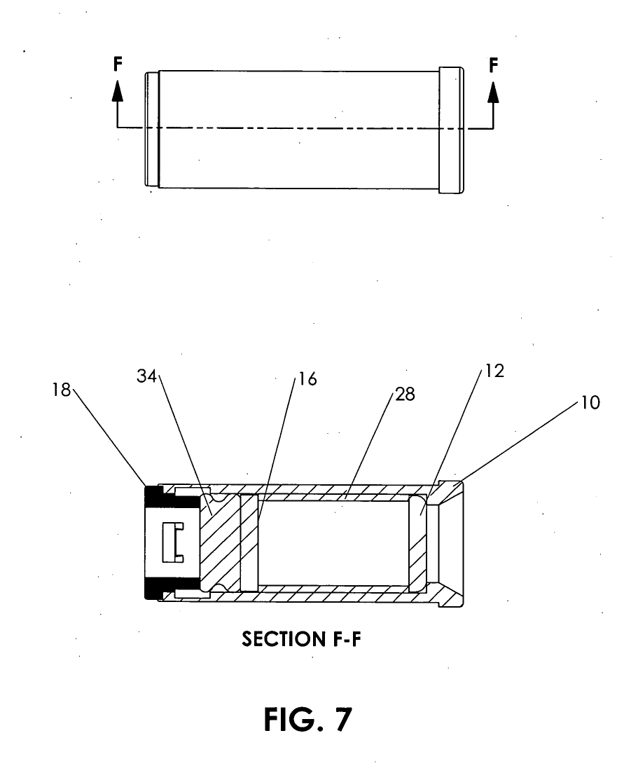

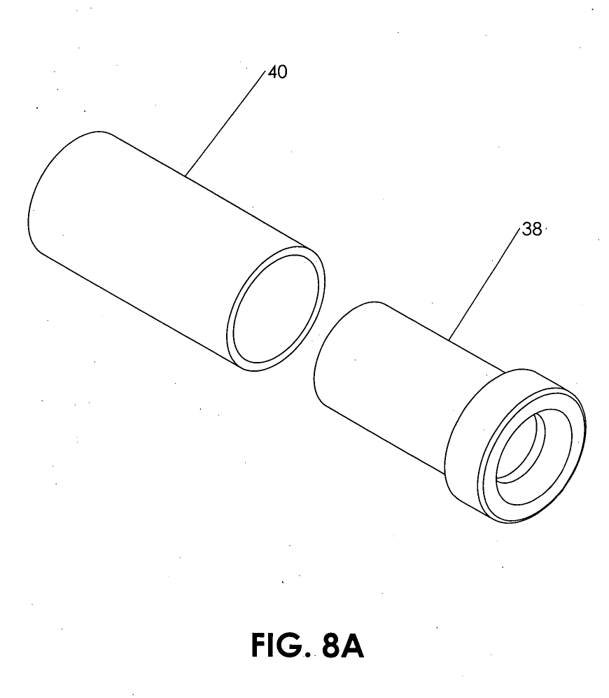

In FIG. 7 the sleeve method is used again for separation. However, during assembly, a compressible item 34 has been added after the filter and before the plug is inserted into the retaining groove. Compared to our preferred method, this assembly has a larger number of parts which adds expense. The compressible item drawn as a spring in FIG. 7 could also be replaced with any compressible material such as; a disc washer, rubber washer, etc.

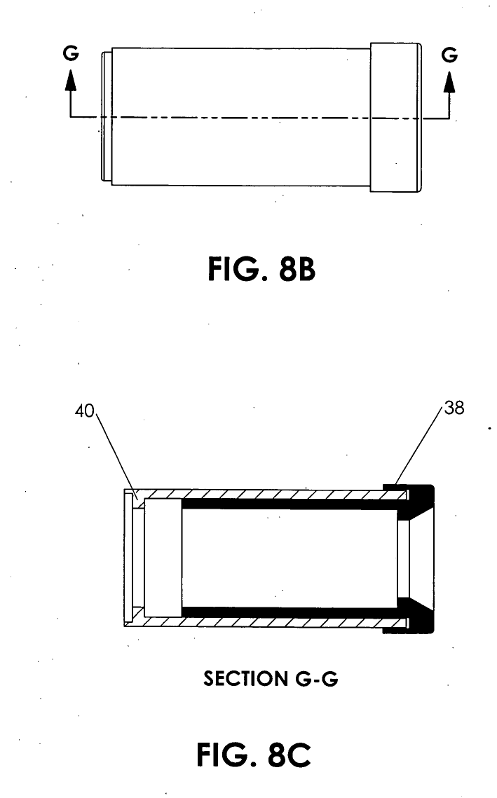

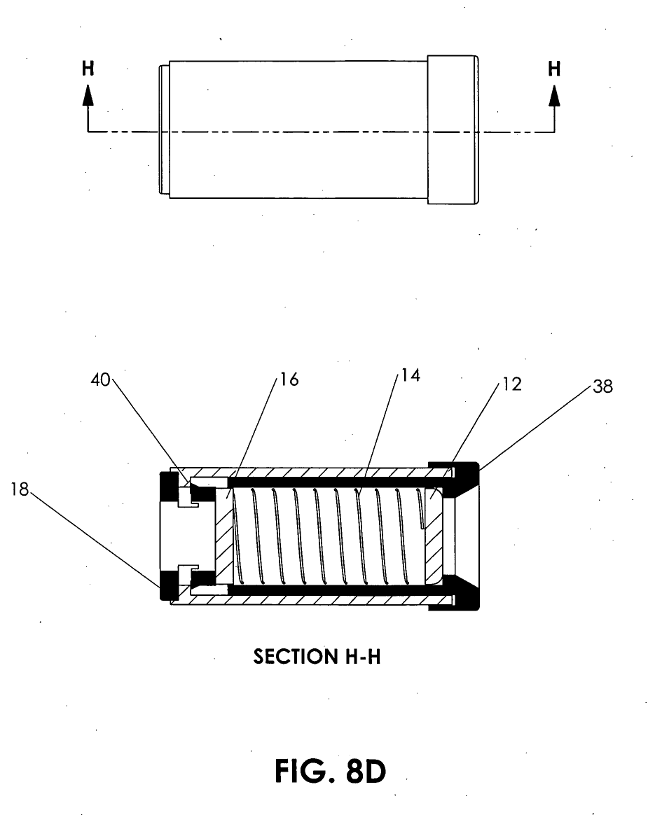

In FIG. 8A the isometric exploded view of the two part housing is shown separated to give an overall understanding of how an inner housing 38 will need to be pressed or glued into an outer housing 40. A press fit could be facilitated by a slight taper on one, or both of the housings. FIGS. 8B and 8C show in more detail how the two parts look once they have been pressed or glued together. The approach described in these views is very similar to the method shown in our preferred sketches FIGS. 1A-1D. The two part housing would be assembled so that the parts could not be separated. FIG. 8D shows how the internal components fit into this style housing. The advantage to this method is that the housings could be inexpensively mass produced with molds. Another advantage to this method is the outer sleeve could be made in different colors depending on the request of a customer or distributor.

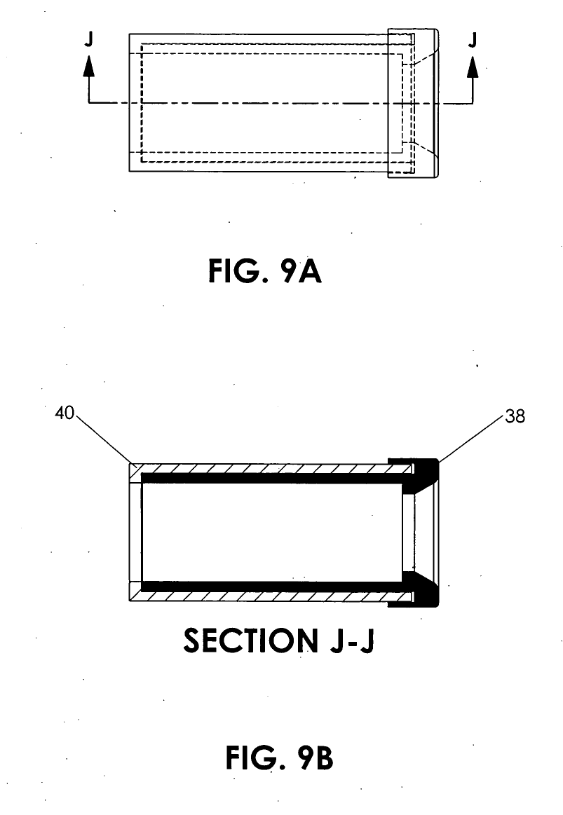

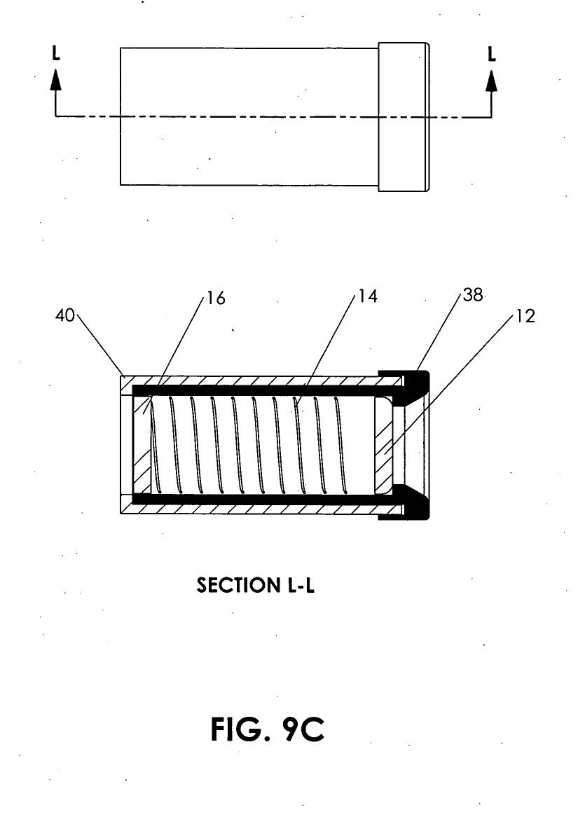

In FIGS. 9A and 9B the outer housing is used to enclose the internal components without the need of an additional plug, threaded device or other retaining item. This method was developed for a mass production purposes and should be noted that the housing would not likely be accessible for repairs. If manufactured from plastic, the housing would be inexpensive enough to replace the entire unit without the need to access internal parts. FIG. 9C shows the how the internal components would fit into this style housing.

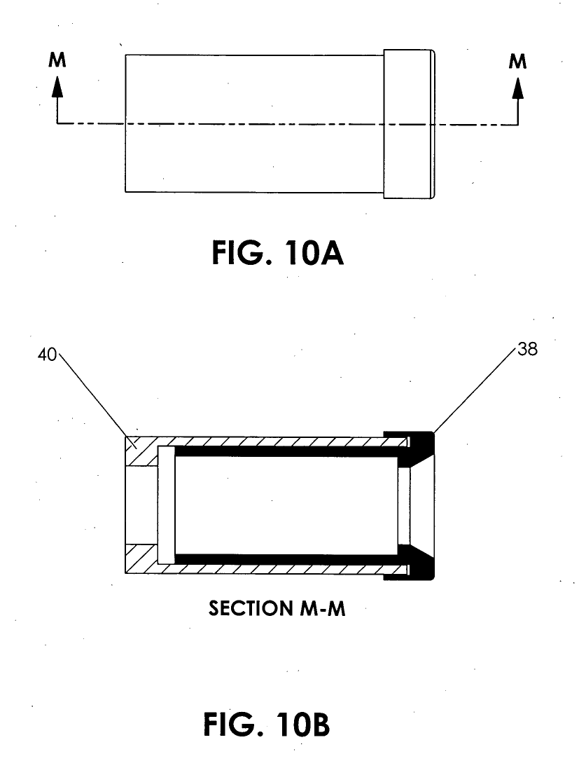

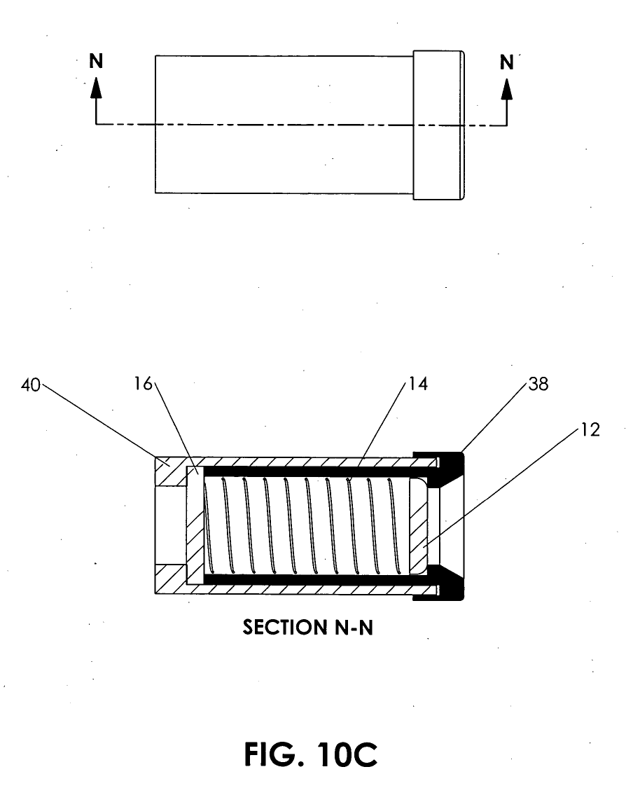

In FIGS. 10A and 10B shows how after the inner and outer housings are pressed together, a space remains that will be used to seat one of the internal components, or an internal component with a cushioning device such as a rubber washer or O-ring. The other internal components would be seated using the spring mentioned in many of the other methods including our preferred method. FIG. 10C shows a lens 16 being seated by the outer and inner housing in the space mentioned.

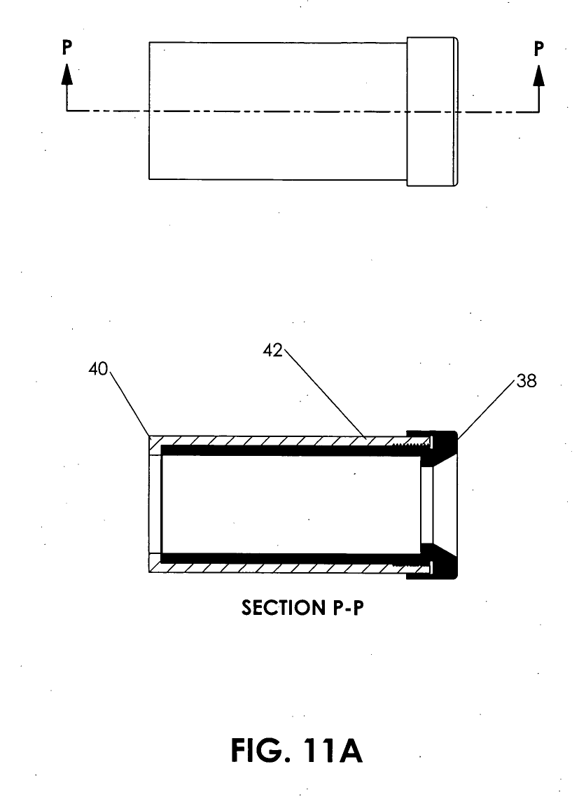

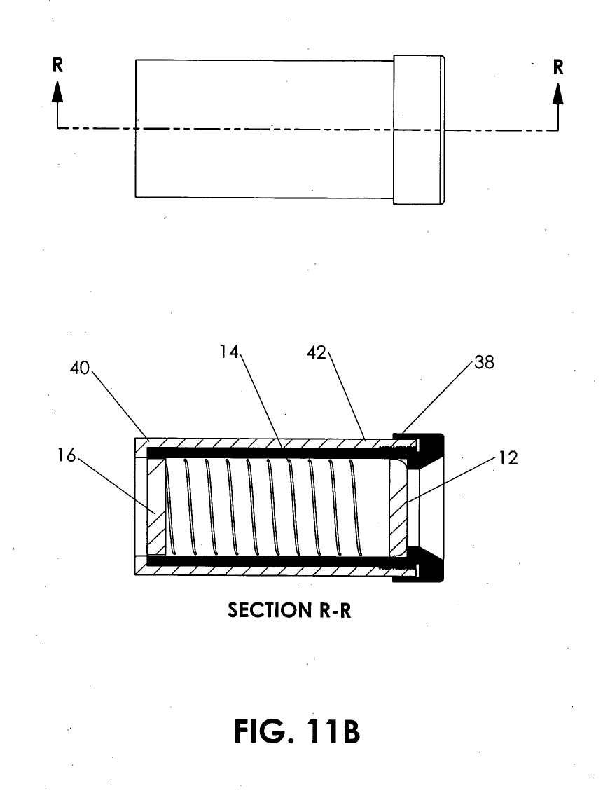

In FIGS. 11A and 11B the two housings are threaded and spun together. Although this method would entail expensive machining cost during assembly the two housings can be adjusted to accommodate different thicknesses of internal elements. This method also allows for easy access to internal parts for repair, or to substitute different types of internal optical components, such as magnifiers of differing strength, achromatic lenses instead of chromatic lenses, etc.

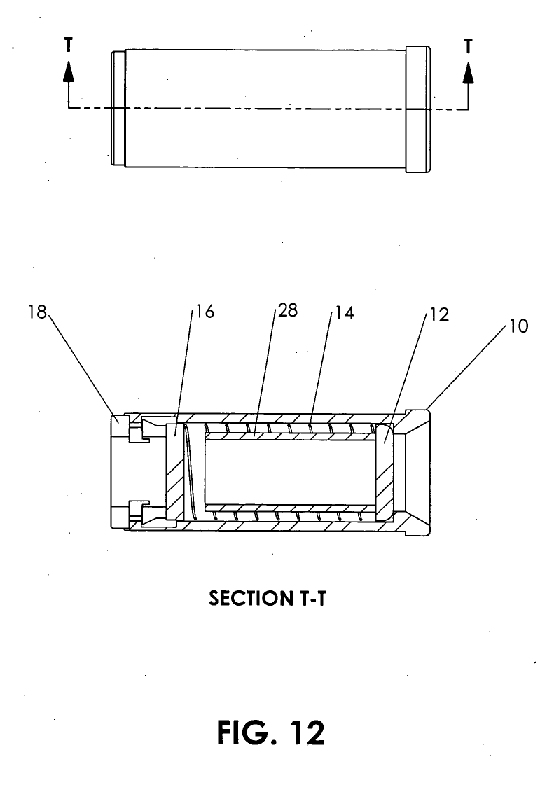

In FIG. 12 the sleeve method is being used to hide the spring that is still being used to seat the lens and filter. This method could be used for large diameter optical housings where the spring would be visible. It is important that the sleeve is shorter than the separation distance created by the spring pushing the lens and filter apart.

### CONCLUSION, RAMIFICATIONS, AND SCOPE

Our design eliminates the need for special tools, adhesives or a considerable amount of time for assembly of an optical device. With a spring being used between the lens and filter it will automatically separate the internal components and properly seat them. With this method the spring and internal components could be held in the housing using a threaded insert as shown in FIG. 5. However it is not recommended because our preferred method has been developed to eliminate these additional processes for the assembly. After the internal components have been placed into the housing a nylon plug is used to enclose the components.

While my above description contains much specificity, these should not be construed as limitations on the scope of the invention, but rather as an exemplification of one preferred embodiment thereof. Many other variations are possible. For example, the housing is not limited to one particular diameter or material such as plastic, aluminum, steel, etc. The inside and outside diameters are determined by the material being used for the housing and by the size of the lens, filter and other possible internal components. The shape of the housing does not have to be cylindrical as long as the housing can accommodate the circular lens and other related internal components. For example, the housing could have a rectangular shape and then have a bored center. This type of cavity could also be cast and later machined if needed. The optical assembly could use a mentioned retaining method at both ends of the device. For example, the preferred method of a nylon plug could be used at both ends to make them accessible for repairs.

In the mentioned two part assembly methods, the two housings could be threaded and spun together as well as utilizing the press fit, or the glue method for attachment. The two housings could be made out of plastic, metal or a combination thereof. This method also allows for easy access to internal parts for repair, or to substitute different types of internal optical components, such as magnifiers of differing strength, achromatic lenses instead of chromatic lenses, etc.

Accordingly the reader will see that the spring used in the preferred method will separate and seat the internal components while the nylon plug will allow the assembly to be repaired if needed. In addition, the assembly does not require a highly skilled worker to manufacture the final product. The lens or filter described in the preferred and additional embodiments can be replaced with a variety of materials in any of the mentioned optical assemblies. For example the filter could be a piece of protective glass, plastic, mirror or other optical element. The type of materials present inside the housing are not limited to the numbers previously mentioned. For example a piece of glass could be placed in front of the lens to protect the more expensive lens from getting scratched or damaged. The same is true for the opposite end of the housing. Also the assembly is not limited to only one compressible item to separate and space internal components. For example, two or more springs, disc washers or other compressible items could be used in series to properly seat and separate different lenses, filters, mirrors and other materials.

Accordingly, the scope of the invention should be determined not by the embodiments illustrated, but by the appended claims and their legal equivalents.

1. An optical device assembly method, comprising
1 a housing with a cylindrical cavity for accommodating a variety of internal components
2 a compressible item as a means to separate said internal components
3 said compressible item as a means to seat internal components
4 a retainer as a means to enclose internal components in said housing
